(19) United States
(12) Patent Application Publication
(10) Pub. No.: US 2009/0222927 A1
(43) Pub. Date: Sep. 3, 2009

(54) Concealment of Information in Electronic Design Automation

(76) Inventor: Fedor G. Pikus, Beaverton, OR (US)

Correspondence Address: KLARQUIST SPARKMAN, LLP, 121 S.W. SALMON STREET, SUITE 1600, PORTLAND, OR, 97204, US

(21) Appl. No.: 12/226,943

(22) PCT Filed: Apr. 30, 2007
(86) PCT No.: PCT/US2007/010379

§ 371 Date: Mar. 12, 2009

Related U.S. Application Data
(63) Continuation-in-part of application No. 11/415,438, filed on Apr. 30, 2006, now abandoned.

(51) Int. Cl. G06F 21/00; G06F 17/00

(52) U.S. Cl. 726/26; 700/103

(57) ABSTRACT

In one exemplary embodiment disclosed herein, an electronic design automation tool may receive information related to electronic design automation that contains secured information, such as physically secured information, and annotations to indicate the secured portions of the information. Upon receiving such information, the electronic design automation tool may identify those portions of the information comprising secured information related to electronic design automation, and unlock the secured information for processing. The electronic design automation tool may process at least some of the secured electronic design automation information without revealing that secured information to unauthorized persons, tools, systems, or otherwise compromising the protection of that secured information. That is, the design automation tool may process the secured electronic design automation information so that the secured information is concealed both while it is being processed and by the output information generated from processing the secured information.

### FIELD OF THE INVENTION

The technical field relates to electronic design automation. More particularly, the field relates to the secure exchange of information related to electronic design automation.

### BACKGROUND OF THE INVENTION

Modern electronic systems including circuits are becoming increasingly complex. Thus, it is not surprising that increasingly specialized skills and capabilities are necessary to design and manufacture these complex systems. As these skills and capabilities become more specialized, the cooperative effort of engineers from a number of different entities may be required to successfully design and manufacture such electronic systems. In some cases, one entity may even rely upon the specialized skills and capabilities of an outside organization (e.g., a vendor) to meet a specific design or manufacturing need.

For example, it is now common for electronic system designers to outsource the manufacturing or assembly of their electronic systems to other businesses that specialize in manufacturing. In these scenarios, entities may need to provide information related to electronic design automation (EDA) to their partner entities. Even while providing this information, however, an entity might still desire to maintain control over how much of its trade secrets, capabilities, skills and other confidential is divulged to such partner entities.

In one particular example, a system on chip (SOC) designed by one entity may need to be manufactured by a custom integrated circuit (IC) manufacturer. Foundries associated with these manufacturers usually have constraints on their manufacturing capabilities that may determine whether a particular IC layout selected by a design engineer can be manufactured by the foundry. These constraints are typically expressed as rules written in standardized formats (e.g., the Standard Verification Rules Format (SVRF)) A file comprising such rules can be referred to as a rule file. Thus, a rule file for a particular foundry may inherently disclose that foundry's capabilities, trade secrets or other sensitive information that the foundry may not want revealed to certain parties. Other entities, such as IC designers, may nonetheless need such a rule file to ensure that designed IC layouts can be manufactured by the foundry.

Thus, there is a need for the secure exchange of EDA related information between entities for use in EDA tools, such that each entity can control access to information that it considers proprietary (e.g., trade secrets and other confidential information).

### BRIEF SUMMARY OF THE INVENTION

Described herein are methods and systems for the secure exchange of information related to electronic design automation. According to various aspects of the invention, information related to electronic design automation may be secured by encryption, password protection, obfuscation, physically securing the information, or other security measures. With various implementations of the invention, information related to electronic design automation may be annotated to indicate which portions of the information have been secured.

According to other aspects of the invention, an electronic design automation tool may receive information related to electronic design automation that contains secured information and annotations to indicate the secured portions of the information. Upon receiving such information, the electronic design automation tool may identify those portions of the information comprising secured information related to electronic design automation, and unlock the secured information for processing. With various examples of the invention, the electronic design automation tool may process at least some of the secured electronic design automation information without revealing that secured information to unauthorized persons, tools, systems, or otherwise compromising the protection of that secured information. That is, the design automation tool may process the secured electronic design automation information so that the secured information is concealed both while it is being processed and by the output information generated from processing the secured information.

With still other aspects of the invention, information related to electronic design automation may be secured by encryption methods using one or more keys. Information related to keys used for securing information may be exchanged between parties privately or publicly. In some examples of the invention, an individual or party that secured or is otherwise providing the secured information related to electronic design automation may share key related information along with the secured information. The electronic design automation tool may then use the key related information to unlock the secured information for processing. In another aspect, a password along with a key may be used for securing information related to electronic design automation. The key, password or other security mechanisms may also be user specified. Such security measures may also be selected by the encryption tool, the electronic design automation tool or some other tool.

According to some aspects of the invention, an electronic design automation tool may process electronic design automation related information in a secure manner, and also may secure at least some of the results of such processing. Such secured results may be provided to other electronic design automation tools for further processing without revealing the secured results. Also, one tool may unlock at least some of the secured electronic design automation related information, process the information, and then pass at least some of the information onto another electronic design automation tool for further processing. In some examples of the invention, the first electronic design automation tool may re-secure at least some of the electronic design automation related information prior to transferring it onto another electronic design automation tool for further processing.

In yet other implementations of the invention, the secured information related to electronic design automation comprises rules related to manufacturability of integrated circuits. With some examples of the invention, selected portions of such rules may be secured and provided to an electronic design automation tool, such as a physical verification tool, which then can use the rules to verify whether an integrated circuit layout violates one or more of the rules. The physical verification tool may then provide information related to the evaluation to users of the tool or to other tools in a manner that will conceal rules that have been selected for protection.

In still other implementations of the invention, authentication information associated with a computer application is obtained, wherein the authentication information authorizes use of the application. This authentication information may be provided, for example, by a licensor. An encryption key is generated based on the authentication information, and electronic data (which may be electronic design automation data) is encrypted or decrypted using the encryption key. In some embodiments, the authentication information is software licensing information distributed by a licensor. The authentication information used for generating the key may be selected in part based on whether a user is a member of a group of users. A computer-readable medium may contain instructions that cause a computer to carry out these steps.

Still further examples of the invention may include a data management system having a password manager configured to provide a password to a user, wherein the password is licensing information related to a computer application; an encryption key generator for generating an encryption key according to the password, wherein the password is supplied by the user; and an encryption device that decrypts electronic design automation data according to the encryption key.

According to still other examples of the invention, a system for exchanging electronic data includes a data exchanging party and an application licensor, wherein the licensor provides application licensing information to the data exchanging party, and wherein the data exchanging party generates one or more encryption keys based on the licensing information.

Still other examples of the invention may be implemented by a computer-readable medium containing encrypted electronic data, wherein the data was encrypted using an encryption key, and wherein the key was generated based on software licensing information.

Additional features and advantages will become apparent from the following detailed description of illustrated embodiments, which proceeds with reference to accompanying drawings.

### BRIEF DESCRIPTION OF THE DRAWINGS

FIG. 1 is a block diagram illustrating one embodiment of a system for secure exchange of information related to electronic design automation.

FIG. 2 is a flow diagram describing one embodiment of a method for securing information related to electronic design automation.

FIG. 3 is a flow diagram describing one embodiment of a method of securely processing information related to electronic design automation.

FIG. 4 is a block diagram illustrating one embodiment of a system for secure exchange of information related to electronic design automation using a key for securing unsecured information related to electronic design automation.

FIG. 5 is a block diagram illustrating one embodiment of a system for secure exchange of information related to electronic design automation using key related information embedded in a file comprising the secured electronic design automation information.

FIG. 6 is a block diagram illustrating one embodiment of a system for secure exchange of information related to electronic design automation using a key and a password for securing unsecured information related to electronic design automation.

FIG. 7 is a block diagram illustrating one embodiment of a system for secure exchange of information related to electronic design automation wherein some of the information selected for securing is incorporated by reference to another file.

FIG. 8 is a block diagram illustrating one embodiment of a system for secure exchange of information related to rules governing manufacturability of integrated circuits.

FIG. 9 is a block diagram illustrating one embodiment of a system using keys to securely exchange information related to rules governing manufacturability of integrated circuits.

FIG. 10 is a block diagram illustrating one embodiment of a system for secure exchange of information related to electronic design automation wherein the information selected for securing is physically secured.

FIG. 11 is a block diagram illustrating one embodiment of a system for exchange of physically secured information related to rules governing manufacturability of integrated circuits.

FIG. 12 is a diagram illustrating an exemplary client-server network environment.

FIG. 13 is a diagram illustrating an exemplary method of securely exchanging electronic design automation information using a client-server network, such as the one illustrated in FIG. 12.

FIG. 14 is a block diagram illustrating one embodiment of a system for generating encryption keys according to authentication information.

FIG. 15 is a flow diagram describing one embodiment of a method for generating encryption keys using authentication information.

### DETAILED DESCRIPTION OF THE INVENTION

Various novel and unobvious features and aspects of embodiments of the invention are described herein, both alone and in various combinations and sub-combinations. Other embodiments of the invention may incorporate alternate combinations of one or more of these disclosed features and aspects, either alone or in various novel and unobvious combinations and sub-combinations with one another.

Although the operations of the disclosed methods are described in a particular, sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description may sometimes use high-level operation terms such as “determine” in relation to the disclosed methods. Such terms are high-level abstractions of the actual operations that are performed. The actual detailed operations that correspond to these terms will vary depending on the particular implementation of the invention, and are readily discernible by one of ordinary skill in the art.

Some of the methods described herein can be implemented in software stored on a computer-readable medium and executed on a computer. Some of the disclosed methods, for example, can be implemented as part of an electronic design automation (EDA) tool. Such methods can be executed on a single computer, or a network of multiple computers. For clarity, only those aspects of the software germane to these disclosed methods are described; product details well known in the art are omitted. For the same reason, the various types of computer hardware that may be used to implement different embodiments of the invention are not described in detail.

### Exchanging EDA Related Information In A Secure Manner

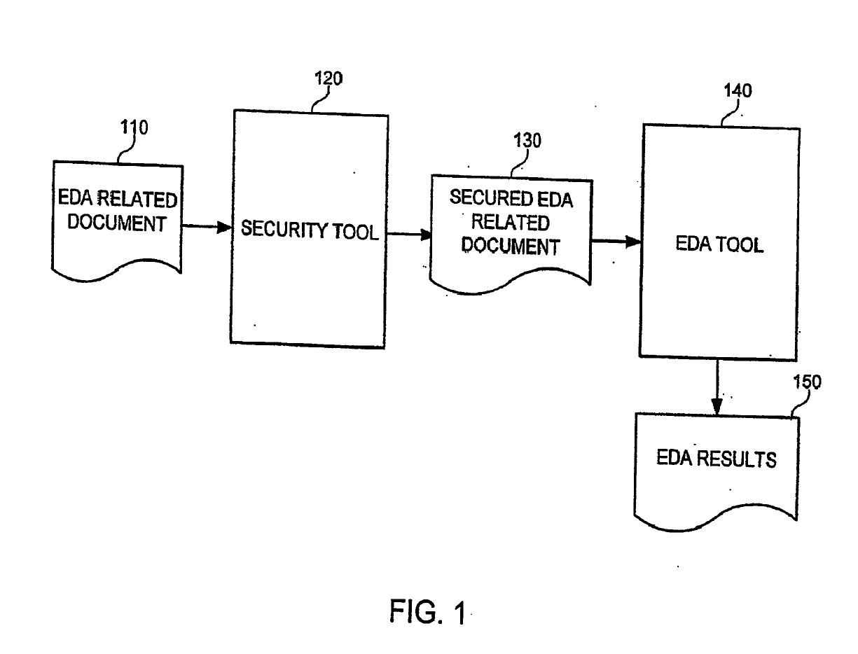

FIG. 1 illustrates an exemplary system for exchanging EDA related information in a secure manner. Documents 110 comprising EDA related information may be secured by a security tool 120 (e.g., encryption tool) to create a document 130 comprising a secured version of the EDA related information prior to being processed by an EDA tool 140. The EDA tool 140 may then unlock the secured information from the EDA related document 130 to use it for processing, which may generate results 150 of interest for a user of the EDA tool 140. In one embodiment, the EDA tool 140 may itself encrypt or otherwise secure the EDA related information 110. In other words, the locus of the securing operation can be anywhere that is suitable for a particular system implementation. Also, information secured by one EDA tool 140 may be passed onto other EDA tools for further processing without revealing contents of the secured information.

In one embodiment, the EDA results 150 may also be provided to a user in a format that does not reveal EDA related information designated to be proprietary or otherwise deserving of protection. For instance, results 150 that may otherwise reveal secured information may just be listed as “Encrypted” or as some other indicator of its protected status. Thus, the EDA tool 140 may secure selected portions of the results 150 to avoid revealing secured information. Also, results that may otherwise reveal secured information may be shared in a limited manner such as listing rule errors in a particular IC layout without revealing the particulars about the rules that were violated by the IC layout.

In this manner, an EDA related document (e.g., 110) comprising intellectual property (IP) may be created by an engineer of one entity and can be shared with engineers of other entities for their use in an EDA tool 140 without having to reveal any sensitive information within the EDA document 110.

### Securing An EDA Related Document

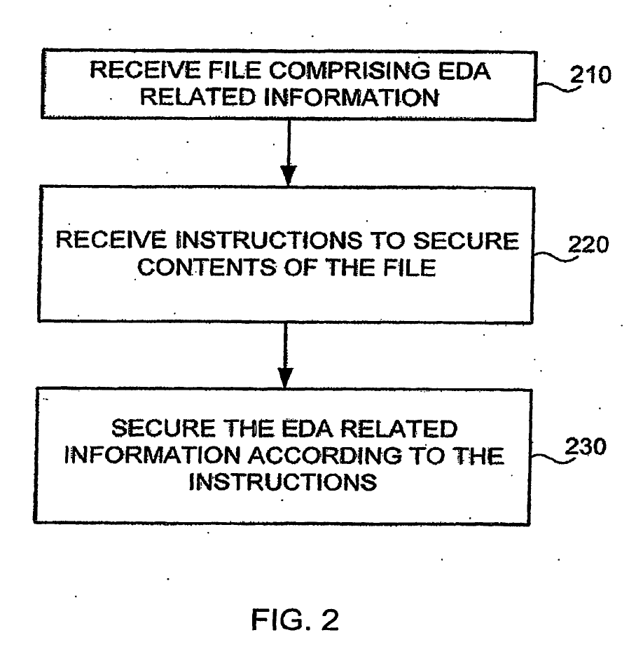

FIG. 2 illustrates an exemplary process for securing information in an EDA related document. At 210, a security tool (e.g., 120 of FIG. 1) may receive EDA related information included in an EDA related document (e.g., 110 of FIG. 1) to be secured. Further at 220, the security tool (e.g., 120) may also receive further instructions regarding a scope and nature of the protection (e.g., by encryption) to be applied to the EDA related information in the EDA document (e.g., 110). For instance, the entire EDA related document (e.g., 110) need not be designated as deserving or otherwise needing protection. Thus, a selected portion of the EDA related document (e.g., 110) may be secured. Thus, a security tool (e.g., 120) may receive instructions at 220 that indicate one or more portions of an EDA related document (e.g., 110) to be secured. These instructions may also include other data related to securing the EDA related document (e.g., 110). For instance, such information may include data related to a key for encryption, a password or other data for securing EDA related information. At 230, the EDA related information is secured according to the instructions.

In one embodiment, these instructions may be part of the EDA related document (e.g., 110) itself. For instance, an EDA related document (e.g., 110) itself may be annotated with instructions that indicate portions of the document that are to be secured. Thus, at 230, the security tool (e.g., 120) may secure only portions of the EDA related document (e.g., 110) designated for protection according to the instructions. Alternatively, the instructions related to securing the EDA related information may also be separate from the EDA related document itself (e.g., 110) and thus, may be received by the security tool 120 separately. Also, the instruction may not be received from outside the security tool 120. Instead, the instructions may originate from the security tool 120.

### Processing Secured EDA Related Information By An EDA Tool

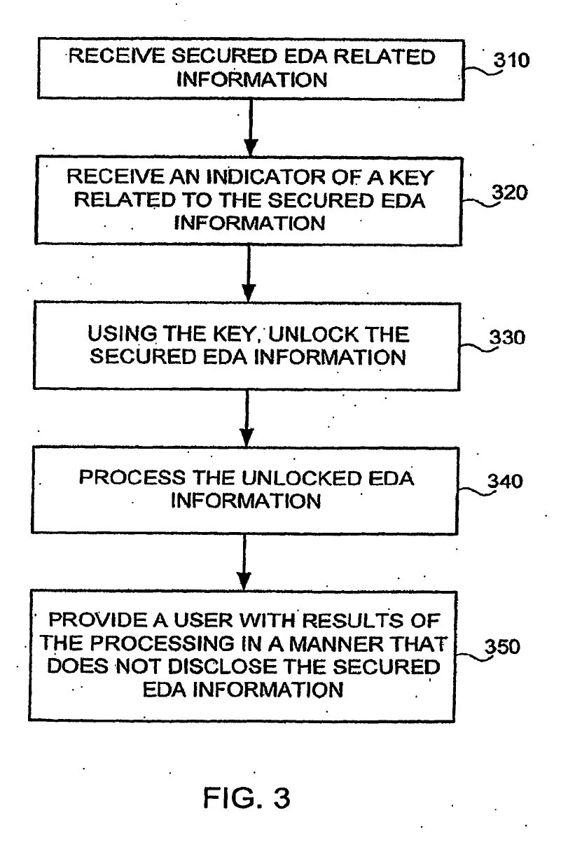

FIG. 3 illustrates an exemplary method for processing secured EDA related information by an EDA tool. At 310, the EDA tool (e.g., 140 of FIG. 1) receives encrypted or otherwise secured EDA related information within an EDA related document (e.g., 130 of FIG. 1). Depending on the method chosen for securing the information, at 320, the EDA tool (e.g., 140 of FIG. 1) may also receive data related to a key, a password, or other information associated with the securing the EDA related information in the document (e.g., 130 of FIG. 1). For instance, in case of information secured via encryption, data related to a key, a password or other data related to securing EDA related information may be received. At 330, such data associated with securing the information may be used to gain access to the secured portion of the EDA related document (e.g., 130). At 340, the EDA tool (e.g., 140) may process the now unlocked EDA related information and at 350, provide a user with results of the processing in a manner so as to not reveal any sensitive portions of the EDA related information (e.g., any portion of the secured information that is to be concealed from the user of the EDA tool).

More particularly, the EDA tool 140 will produce output data from executing designated process operations. With various examples of the invention, this output data will not include any information that would reveal the nature of the secured information that was used to produce the output data. The output results may thus omit any reference to the portion of the electronic design information. The EDA tool 140 may, for example, perform a design rule check analysis of a circuit design layout. With this example, the output data may identify problem structures in the design layout. The output data would not include, however, any information relating to the rules that the structures violated. Alternately, the output data may obfuscate any references to the secured information. For example, references to the secured information in the output data might use code words meaningful only to authorized persons. Alternately or additionally, references to the secured information in the output data might be encrypted. Of course, some implementations might use a combination of both omission and obfuscation to avoid having the output data reveal the secured information used to create the output data.

In addition to this output data, the EDA results 150 also may include related information. For example, the EDA tool 140 might produce a log of the operations it performs. With various examples of the invention, such a log will omit or obfuscate any references to the secured information. Still further, the operation of the EDA tool 140 might produce error messages during its operation. Again, with various embodiments of the invention, the error messages will omit or obfuscate any references to the secured information. For example, if the perform a design rule check analysis of a circuit design layout, it might normally produce an error message stating, e.g., “the WIDTH MEASUREMENT OPERATION requires a layer of type 1.” With various examples of the invention, this error message might instead state “the ENCRYPTED OPERATION requires a layer of type 1,” or even “a layer of type 1 is required to complete this stage of the process.” In the manner, the use of the WIDTH MEASUREMENT OPERATION to produce the output data is concealed. Still further, the EDA results 150 may include summary files. With various examples of the invention, these summary files will omit or obfuscate any references to the secured information.

The decrypted or otherwise unlocked EDA related information may be passed on to other EDA tools for further processing and generating other results without revealing sensitive EDA related information. The information that is secured when passed from one tool to another may be the same information that was initially secured or may be a subset or super set of such information. Additionally, one EDA tool (e.g., 140 of FIG. 1) may secure the results (e.g., 150) from processing the secured EDA related information (e.g., 130) and provide such secured results (e.g., 150) to other EDA tools for further processing without revealing the secured EDA information (e.g., 130). For instance, an EDA tool used for layout versus schematic (LVS) verification may process EDA related information such as layout and schematic data and provide results comprising netlists. These netlists then may be provided to other EDA tools such as parasitic extraction tools (PET) for further processing without revealing the secured information.

With various examples of the invention, the EDA results 150 provided directly or indirectly to another EDA tool will be configured to protect the secured information used to create the results 150. For example, if the EDA results 150 includes design data that will be stored in a database prior to use by another EDA tool, then the results 150 (or portions of the results 150) may be encrypted or contain obfuscated information to prevent unauthorized access to the secured information through the results 150. If the EDA results 150 are provided directly to another EDA in a secure manner that will prevent unauthorized access, then the results 150 may still include indicators indicating that one or more portions of the results should be protected. In this manner, the original secured information may be protected, even if results obtained using this secured information are subsequently employed by a series of EDA tools.

### Indicating Secured EDA Related Information In An EDA Related Document

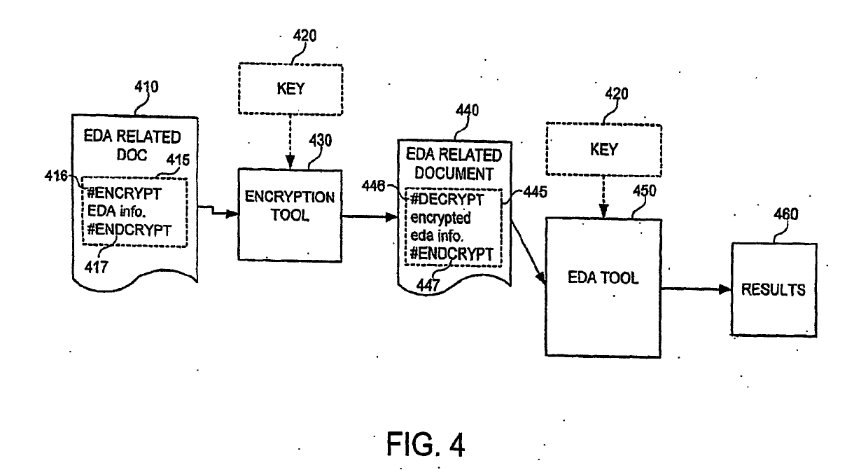

FIG. 4 illustrates an exemplary method for indicating portions of an EDA related document that should be subject to protection. For instance, in an EDA related document (file) 410, the EDA related information 415 to be secured may be indicated as information that is enclosed within a starting tag (e.g., “#ENCRYPT” at 416) and a closing tag (e.g., “#ENDCRYPT” at 417). Furthermore, in an EDA related document comprising encrypted or otherwise secured EDA information at 440, the secured portion of the document 445 may also be indicated by a starting tag (e.g., “#DECRYPT” 446) and a closing tag (e.g., “#ENDCRYPT” 447). This can indicate to an EDA tool 450 where to begin and end decryption or other methods of unlocking secured information. Such language is exemplary. Other words or character sets can also be used to signify the beginning and end of a section of code to be encrypted, decrypted or otherwise secured and unlocked. Also, more than one portion of an EDA related document 410 may be designated for protection and may be placed between different or the same start and end designators. Other tags or indicators may also be suitably used.

In one embodiment no such explicit indicators are used. For instance, portions of the EDA related document or electronic file to be secured may be determined based on whether the portions relate to a header, a body or some other selected portion of the file. For instance, the body may be secured whereas the header may not be secured. Furthermore, a user, or a tool may indicate that data related to selected subjects such as netlists, design rule checking (DRC), optical, process correction (OPC) and other suitable EDA information should be secured. For decrypting or otherwise unlocking secured information, a system may presume, for example, that all illegible data in a secured file should be decrypted or otherwise unlocked.

### Securing Information Within EDA Related Documents

Several methods may be used for securing information within EDA related documents. For instance, encryption is one such method. For encryption, a block cipher method such as, advanced encryption standard (AES) can be used by an encryption tool. Alternative encryption methods can include the Rivest, Shamir, and Adelman (RSA) encryption, Data Encryption Standard (DES), simple dictionary key permutation, or other suitable encryption methods. However, the securing of the portion of the EDA related document is not limited to encryption. For example, the portion to be secured can be further or alternatively secured through other suitable securing including obfuscation and/or one-way hashing.

### Uses Of Keys In The Process Of Securing EDA Related Information

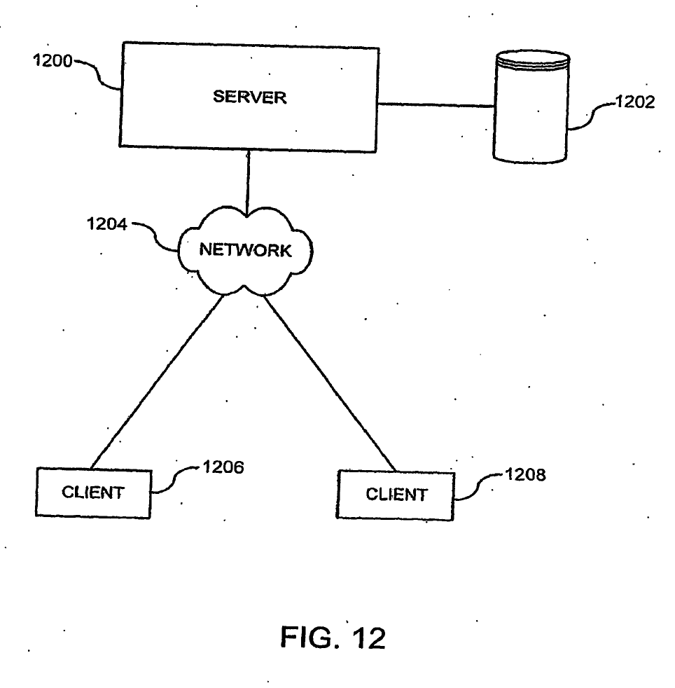

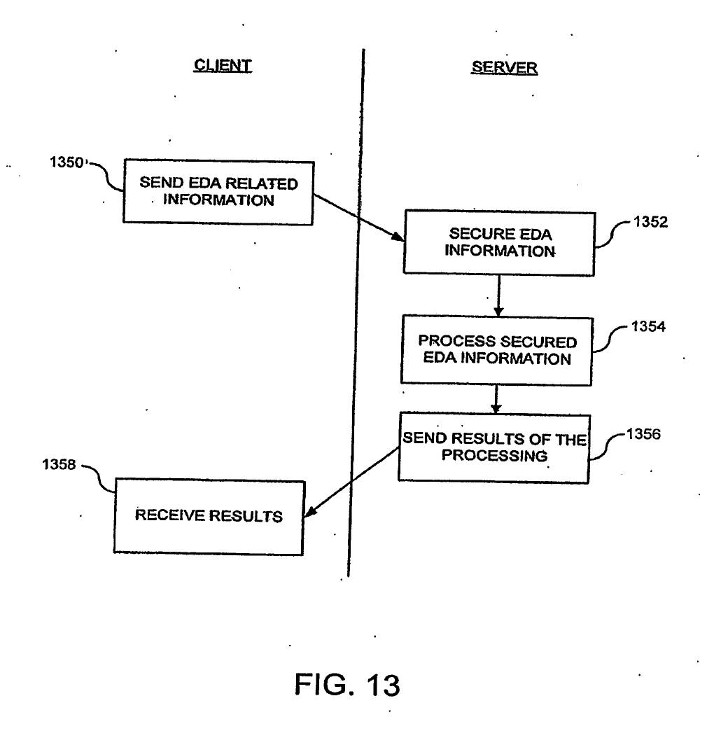

FIG. 4 illustrates systems and methods of encrypting EDA related information with the use of keys. As shown in FIG. 4, an encryption tool 430 may use a key 420 to encrypt EDA related information included in the EDA related document 410. The key may be, for example, specified by a source external to the encryption tool 430. The key 420 may also be selected randomly by the encryption tool 430. In a further embodiment, described below and in FIGS. 12 and 13, one or more keys may be generated using system authentication information. The key 420 can then be provided to a user of the EDA tool 450 to be used for decrypting the EDA related information. The EDA tool 450 may also generate the results 460 without revealing any of the decrypted EDA related information used by the EDA tool 450.

In one embodiment, the exchange of the key 420 may be a public key exchange. For instance, a third party may be used to broker the exchange of key related information. The exchange of the key 420 may also be a private exchange.

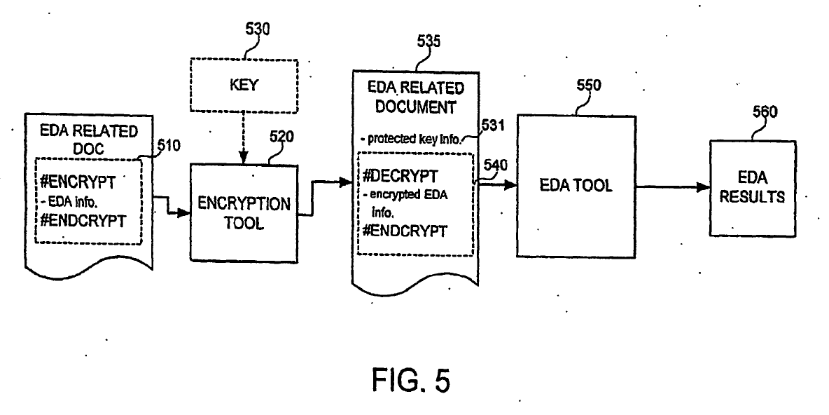

FIG. 5 illustrates yet another exemplary method of encrypting EDA related information using keys. For instance, an encryption tool 520 may encrypt EDA related information 510 using a key 530. Furthermore, information 531 related to the key 530 used for encryption may be included within an EDA related document 535 comprising the encrypted EDA related information 540. Thus, instead of obtaining the key 530 publicly, the key exchange between entities may be private. The key related information 531 may itself be obfuscated, encrypted, password protected or otherwise afforded suitable protection. To decrypt the secured EDA information the EDA tool 550 may first need to obtain access to the protected key related information 531. The EDA tool 550 may then use the unsecured version of the key related information 531 to obtain a key 530 to decrypt the encrypted EDA related information 540 for processing. Also, the key related information 531 may comprise the key itself.

The key 530 may be specified by a user of the encryption tool 520. Alternatively, a key may be randomly selected by the encryption tool 520. The encryption tool 520 may select the key 530 from an array of master keys to which it has access. Alternatively, the EDA tool 550 may match the key related information 531 to one or more keys in an array of master keys for unlocking a secured EDA document 535.

### Uses Of Keys Along With Passwords For Securing EDA Related Information

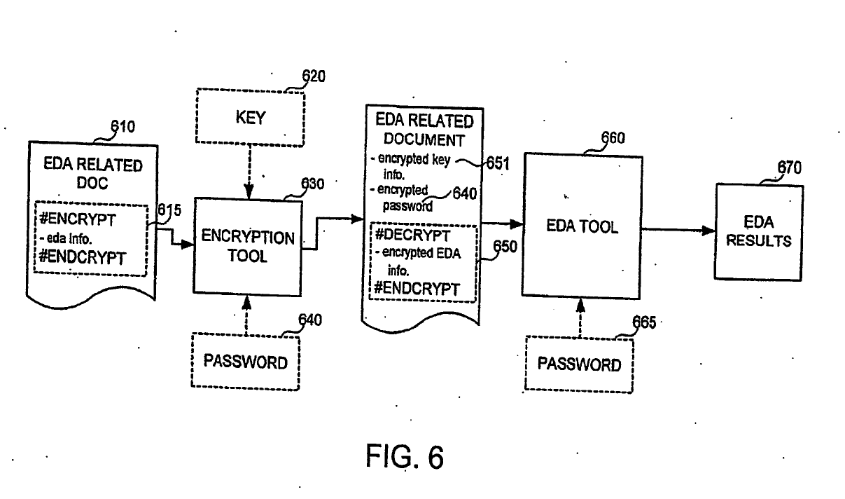

Alternatively, as shown in FIG. 6, in addition to a key 620, a password 640 may be used in the encryption of EDA related information 615. In one embodiment, the password may be embedded along with the encrypted EDA related information 650 received by the EDA tool 660. It may then be decrypted by the EDA tool 660 and matched to a user entered password 665 before providing the results 670 to a user. Additionally, the EDA tool 660 may not even process the decrypted EDA related information unless there is a match between the password 665 obtained from a user and one at 640 obtained along with the encrypted EDA related information 650.

Alternatively, a password 640 may be used to encrypt, obfuscate, protect, or otherwise alter the key related information 651 embedded along with the encrypted EDA related information 650. Then, the EDA tool 660 may require that a user of the EDA tool 660 provide it with the password 665 before attempting to decrypt the key related information 651 embedded along with the EDA information. Also, a key itself may be encrypted, obfuscated, or otherwise protected by a password 640.

### Password And Key Generation

In some embodiments, encryption keys can be built into a software program, or they can be derived from a password that is input by a user. However, built-in software keys can present an unacceptable vulnerability by using the same key for many copies or every copy of a software program. Keys derived from a user-input password can require an additional system to distribute passwords to users, and it can be difficult to distribute the passwords securely. Additionally, in some organizations it can be desirable or necessary for large numbers of users to generate encryption keys as needed. If one or more passwords are distributed to a large number of those users, this can create a correspondingly large risk that a password will be compromised.

In another embodiment, a public and private key pair can be generated by a data-exchanging party, such as a customer of a foundry. The public key can be transmitted from the customer to the foundry in an open channel, and the foundry can then use the public key to encrypt electronic data to be sent to the customer. The customer then uses the private key to decrypt electronic data from the foundry. One possible solution for handling private keys is to use a central key authority, such as those employed by Internet web browsers (e.g., VeriSign). However, this usually requires opening a customer's computer to a network such as the Internet, and a customer can be unwilling to do this (e.g., for security reasons).

One embodiment utilizes a system where a user is associated with one or more user groups. The user groups can be associated with one or more keys or sets of encryption keys or with data used to generate one or more keys. In such a system, an encryption key becomes available to a user when the user demonstrates membership in one or more of the user groups. A user can demonstrate membership in a user group by providing authentication information. “Authentication information” is meant broadly and comprises information which is already possessed by the user and shows that the user meets one or more criteria. For example, the authentication information can be a login name and password showing that a user is a member of a user group that is permitted to access a network. As another example, the authentication information can be licensing information indicating that the user is licensed and authorized to use a given software program. (Examples of licensing information are described below.)

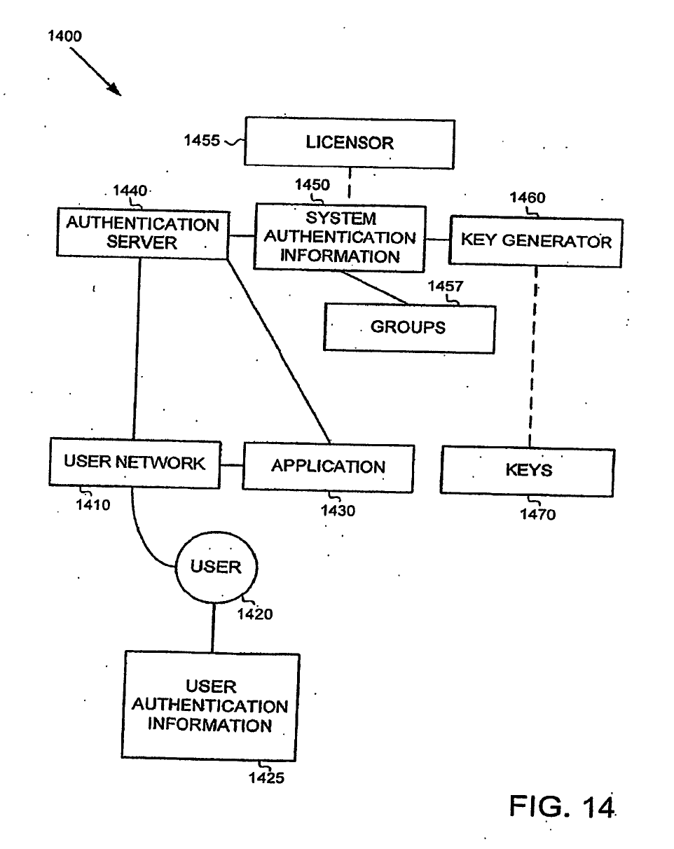

In one embodiment, an encryption key can be generated using authentication information. FIG. 14 shows one embodiment of a system 1400, which comprises a user network 1410. In one embodiment, user network 1410 comprises a LAN, and in other embodiments it comprises a WAN or the Internet. A user 1420 can request permission from authentication server 1440 to perform various actions over user network 1410 (e.g., operate software programs, transmit files, encrypt data). In one embodiment, user 1420 can provide user authentication information 1425 to authentication server 1440 via user network 1410 using, for example, a login dialog box or a web portal. The user authentication information 1425 can comprise a user name and password, biometric information, an RFID tag, a PIN, or other types of similar information as are known in the art. Authentication server 1440 can consult system authentication information 1450 as part of determining whether to grant the request of user 1420. System authentication information 1450 can be similar to user authentication information 1425 in that it can show that a user meets one or more criteria. However, it is usually not provided to system 1400 by a user, but by a licensor 1455. Licensor 1455 is usually a third party (or multiple third parties) and can be an issuing authority, such as a software manufacturer. It can distribute system authentication information 1450 to a licensee by a number of open or private methods, including e-mail, physical distribution, or a network such as the Internet. In another embodiment, licensor 1455 can also distribute system authentication information 1450 via another party known as a licensor designee (not shown). System authentication information 1450 may be generated by the licensor 1455 with or without input from other parties (e.g., user 1420) and can be stored on a computer-readable medium (not shown). In some embodiments, authentication server 1440 can access system authentication information 1450 through a computer network authentication protocol, such as Kerberos. Many organizations which use EDA tools or other software have in place systems such as system 1400 to handle software licensing.

System authentication information 1450 and/or user authentication information 1425 can be used by a key generator 1460 to generate one or more keys 1470. For example, in one embodiment key generator 1460 uses only user authentication information 1425 (e.g., a user password) provided by user 1420, while in another embodiment it uses only system authentication information 1450, while in yet another embodiment it uses a combination of both. Keys 1470 can be used with encryption tools, as described in the example systems and methods above, for example.

In one embodiment, authentication server 1440 can determine if user 1420 belongs to one or more user groups 1457. Based on this determination, key generator 1460 uses a particular piece or pieces of system authentication information 1450 to generate keys 1470. In this embodiment, different users 1420 belonging to one or more groups can supply different pieces of user authentication information 1425 to authentication server 1440, resulting in key generator 1460 creating multiple keys or the same key. For example, three users 1420 can provide three unique passwords to authentication server 1440. Authentication server 1440 can determine that these three users belong to the same user group and cause the key generator 1460 to generate one key 1470 for all of these users using system identification information 1450. As another example, authentication server 1440 can determine that three users do not belong to a group or groups 1457 and accordingly cause key generator 1460 to generate a unique key 1470 for each user, perhaps using the unique passwords to generate the keys. The unique keys can be treated as equally valid by the system 1400.

In another embodiment, system 1400 further comprises an application 1430, and user network 1410 and authentication server 1440 can allow user 1420 to interact with application 1430. Application 1430 can be a number of different software packages, desirably an EDA tool. User 1420 is allowed to access application 1430 as permitted by authentication server 1440. In this or similar embodiments, licensor 1455 can be associated with (e.g., a publisher of) application 1430, and system authentication information 1450 can be licensing information related to application 1430. The authentication server 1440 can use a software license manager such as FLEXlm (also known as FLEXnet) from Macrovision. When user 1420 requests permission to run application 1430, authentication server 1440 consults system authentication information 1450 (and, in some embodiments, groups 1457) to determine whether user 1420 can use application 1430 and accordingly grants or denies the request. The system authentication information 1450 can comprise a dongle, a licensing key, a token, a software or hardware serial number, online authentication credentials, or another persistent, immutable identifying item used for digital rights management. The licensing information can be the same or similar for a group of users or for all users in system 1400.

It should be noted that while the licensing information 1450 is described above as being “persistent and immutable,” this does not necessarily mean that it can never be changed. For example, in one embodiment, licensor 1455 (or a licensor designee) can periodically, randomly, or at varying times issue new licensing information, which can cause the key generator 1460 to produce a new key pair.

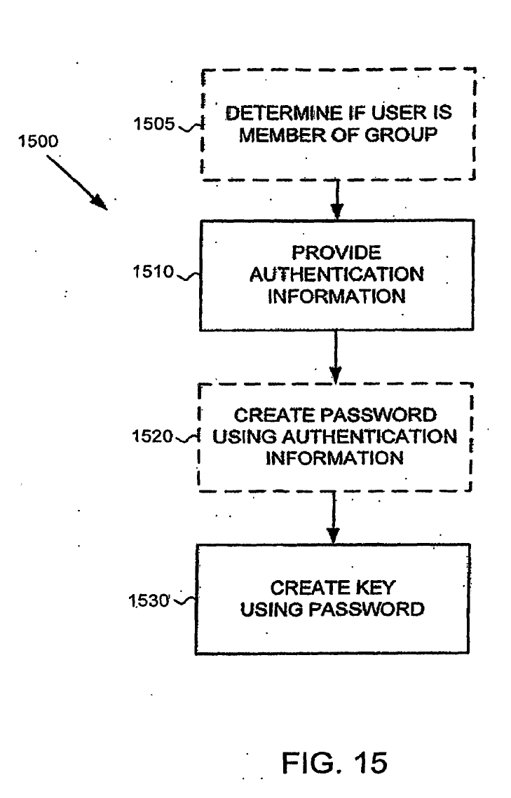

FIG. 15 shows a method 1500 for using authentication information to generate one or more keys. In one embodiment, method 1500 is used when a need arises to decrypt a file using a private key (e.g., a customer receives a rule file from a foundry that has been encrypted using a corresponding public key). Alternatively, the method can be used when a public key is needed for sending information to another party (e.g., a foundry). One embodiment comprises an optional step of determining whether a user is a member of one or more groups (step 1505). In this case, authentication information (user authentication information 1425 and/or system authentication information 1450) is provided to key generator 1460 (step 1510) based on this determination. In another embodiment, authentication information is provided to key generator 1460 without such a determination. In either case, authentication information can be used to create a password (step 1520), and the password is then used to create one or more keys (e.g., a public and private key pair, as is well known in the art) (step 1530). Alternatively, the authentication information itself can be used as the password when creating the keys 1470, and thus step 1520 can be optional.

Method 1500 is desirably used with licensing information for an EDA tool, but can also be used with licensing information for other types of software, as well.

This method of password and/or key generation can have several advantages. For example, it can eliminate the need for a user (or someone associated with the user, e.g., the user's employer or system administrator) to manage one or more additional passwords, and it can also eliminate the need for an additional, secure channel to transmit additional passwords to one or more users. The described method can be implemented such that the keys are generated transparently, as the user would not be prompted for a password. Additionally, it can employ an infrastructure (e.g., the authentication server) that can already be present in a customer's computer network.

### Encryption Of EDA Related Information In Files Referred To Within An EDA Related Document

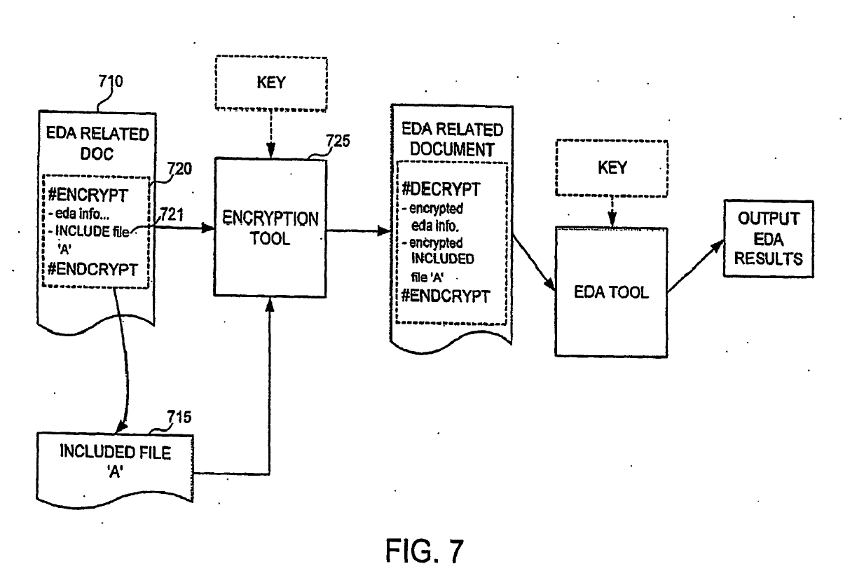

In some instances, EDA related documents may refer to or otherwise rely on information included in another file. For instance, as shown in FIG. 7, a file ‘A’ 715 and hence, any information stored within file ‘A’ 715 may be referred to within an EDA related document 710. If, for instance, such a file is referred to within EDA related information selected for encryption 720 then the encryption tool 725 may be triggered by an instruction such as a “#INCLUDE” instruction 721 to access the file 715 and encrypt it along with the other EDA related information designated for encryption at 720. The “#INCLUDE” instruction is an exemplary syntax. Other syntax may also be used to achieve the same result. Other files and any information included therein may be encrypted in a similar manner. In this manner, multiple files from multiple sources may be secured and processed.

### Encryption Of EDA Information Related To IC Manufacturing

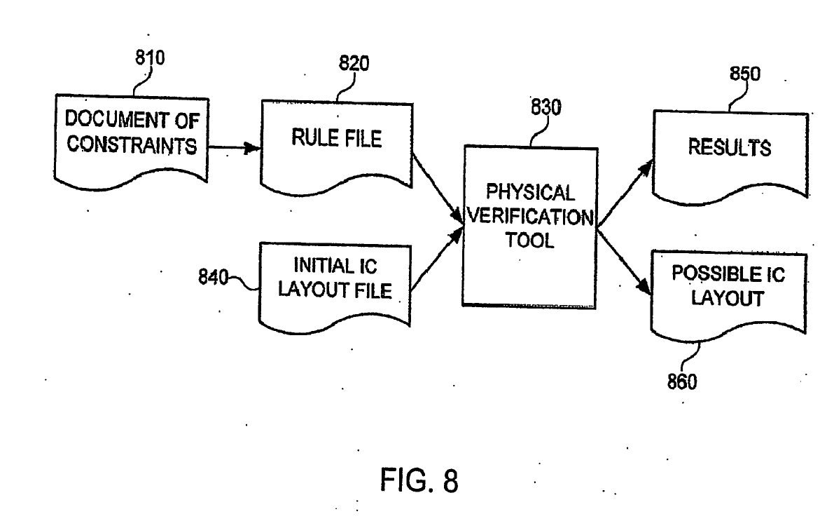

One particular application of methods described above for secure exchange of EDA related information between entities may involve the exchange of such information for determining the manufacturability of certain IC layouts based on constraints of a particular manufacturer (e.g., a foundry). FIG. 8 is a block diagram illustrating an embodiment of one such method of determining the manufacturability of a given integrated circuit (IC) layout. An IC manufacturer (e.g., a foundry) may have certain manufacturing constraints that apply to different IC layouts. An engineer, such as a process engineer, might create a document of constraints 810 that contains information regarding constraints specific to that manufacturer. The document of constraints 810 can be incorporated into a rule deck or rule file 820 (e.g., an ASCII file) that further describes the particular constraints. The rule file may also comprise information such as a picture, a set of design data base objects and schematic representations of the rules. The rule file 820 may then be used with an EDA tool such as a physical verification tool 830 (e.g., Calibre™, a Mentor Graphics Corp. tool) to determine if an initial IC layout 840 (e.g., as described in file types such as GDSII, OpenAccess, and Milkyway) violates the manufacturer's constraints. The physical verification tool 830 may thus be used to determine whether or not the initial IC layout 840 is manufacturable.

In the illustrated embodiment, the physical verification tool 830 may read the initial IC layout 840 and, using the rule file 820, determine if the initial IC layout 840 violates any of the constraints in the rule file 820. The physical verification tool 830 may provide a results file 850 containing a record of any errors encountered in the layout, as well as information regarding the operation of the tool itself (e.g., the amount of time or memory needed for the tool to run its verification). The physical verification tool 830 may also provide a manufacturable IC layout 860 (e.g., a layout in which no constraints are violated) that the design engineer can choose to use or evaluate for manufacture of the IC. If the initial IC layout 840 does not violate any of the constraints, the manufacturable IC layout 860 may just comprise the initial IC layout 840. If the initial IC layout 840 violates at least one constraint, however, the manufacturable IC layout 860 may comprise proposed changes that would make the layout manufacturable.

However, a manufacturer may desire not to reveal a given rule file (e.g., the rule file 820) containing proprietary information considered to be intellectual property (e.g., one or more trade secrets). This may be so because sometimes, for example, the person who writes the rule file 820 is not the same person who runs the physical verification tool 830 that uses the rule file 820 (e.g., the design engineer). Nonetheless, it is often desirable for the manufacturer to provide the engineer with something detailing at least some of the constraints specific to that manufacturer so that a design engineer may determine whether a given IC layout is manufacturable by that manufacturer even if the entire rule file is not revealed.

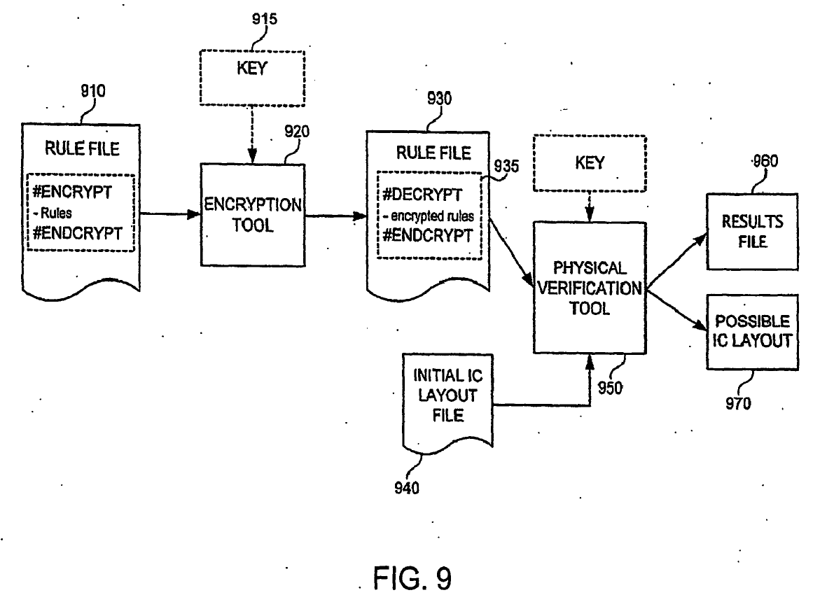

FIG. 9 is a block diagram illustrating an exemplary embodiment of a system for securely exchanging rule files. A rule file 910 may contain information relating to constraints specific to a certain manufacturer. In one particular embodiment, the rule file 910 is written in a known format such as the standard verification rules format (SVRF). The rule file 910 can contain proprietary information that the manufacturer does not want to be discovered by whoever receives the rule file 910. The rule file 910 may also contain other information that may or may not be proprietary and with which the manufacturer is less concerned. Rules to be protected (e.g., rules the manufacturer does not want to be shown in the transcript) can include, for example, layer creation commands, design-rule-checking (DRC) checks, layout-vs.-schematic (LVS) device statements, in-file LITHO operations, optical-and-process-correction operations (e.g., TDOPC and OPCSbar operations), parasitic-extraction (PEX) statements, or FRACTURE commands. This is not an exhaustive list, as the manufacturer, in accordance with this disclosure, can select (or allow software selection of) any information for this higher protection.

As described above, the portion of the rule file 910 comprising such highly proprietary information, or any one or more sections of the file sought to be secured, can be placed between a first set of designated key words in the rule file 910. For example, in one particular embodiment, such key words can be “#ENCRYPT,” signifying the beginning of a section to be secured, and “#ENDCRYPT,” signifying the end of the section to be secured. The modified rule file 910 can then be processed by an encryption tool 920. The encryption tool 920 can secure the portion of the file between “#ENCRYPT” and “#ENDCRYPT” through an encryption process, resulting in an encrypted rule file 930. In one embodiment, the encrypted rule file 930 contains the encrypted portion between a second set of designated keywords, such as “#DECRYPT” and “#ENDCRYPT,” respectively. Other non-encrypted information is desirably also included in the rule file 910, in which case the encrypted rule file 930 is only partially encrypted.

In this embodiment, an optional key 915 is used in the encryption process. The optional key 915 can be a private key, for example. In one particular embodiment, a user selects a key 915 to be used in the encryption process. In an alternative embodiment, a key 915 is randomly selected by the encryption tool 920. The encryption tool 920 can contain or have access to an array of master keys from which it might select a key 915 to use. Alternatively, a user can choose a password to be used in place of or in connection with a key 915. Such a password can be embedded into the encrypted portion of the file at 935 and protected through obfuscation, for example. Alternatively, the password can be used to alter the master key.

The encrypted or partially encrypted rule file 935 can be provided as input, along with the initial IC layout 940, to the physical verification tool 950 for processing. In one embodiment, the physical verification tool 950 decrypts and processes the section or sections 935 of the encrypted rule file 930 between the second set of designated keywords (e.g., “#DECRYPT” and “#ENDCRYPT”) without fully revealing the decrypted section to the user of the physical verification tool 950. The decryption can be done in the run-time memory space of the physical verification tool 950, for example.

### Protecting EDA Information Included In The Results Of Processing By EDA Tools

Referring to FIG. 1, the EDA related information contained within EDA related document 110 and protected by encryption prior to its use by an EDA related tool 140 may lose its protection if it is disclosed to a user of the EDA tool 140 via the results 150. Thus, in one embodiment, portions of a result 150 file comprising EDA related information designated as sensitive may be obscured, encrypted, or otherwise altered to prevent the user from learning about any sensitive EDA related information. For instance, with respect to the implementation related to IC layouts 940 described in FIG. 9, the physical verification tool 950 may not produce a full transcription for the secured rules 930. Instead, the physical verification tool 950 may produce only partial transcription of the secured rule file 930 as results 960 so that the secured portion of the rule file 935 is not disclosed.

The physical verification tool 950 can provide other EDA related information as results 960 and, if possible, may optionally provide a manufacturable IC layout 970. Such information can further or alternatively be recorded in a database. Error information related to violations of the constraints in the rule file 910 can be communicated in various ways. In one particular embodiment, error information regarding the secured portion of the rule file 935 is handled differently than error information regarding the rest of the file. For example, error information regarding the secured portion of the file 935 can be limited, whereas error information regarding the rest of the file can be much more detailed. In one embodiment, the error information regarding the secured portion of the rule file 935 simply states how many errors exist in the initial IC layout 940.

For example, an otherwise listed rule might simply be shown as “Encrypted” in the results file 960. In another embodiment, the error information regarding the secured portion describes at least one type of error in general terms, such as indicating that two components are too close together, for example. In an alternative embodiment, the error information regarding the secured portion describes at least one type of error in specific terms, such as detailing which two components are too close together and at what location, for example.

### EDA Tools And EDA Related Information

Some of the examples above (e.g., FIG. 9), discuss methods and systems of secure exchange of EDA related information by illustrating the exchange of IC rule files for use in a physical verification tool. However, physical verification using rule files is only one type of EDA application in which the disclosed methods may be used. Other EDA applications include (but are not limited to) such uses as layout versus schematic verification (LVS), generating parasitic extraction flows (e.g., layout parasitic extraction (LPE)) and applying tools for resolution enhancement technology (RET). Other tools such as synthesis tools, emulation tools and simulation tools may also use EDA related information in a secure manner using the methods and systems described herein.

EDA related information to be secured and processed in a secure manner may include any information related to design for manufacture (DFM) processes, methods, systems and tools. Also, besides rule files, other EDA related information that can be protected using the disclosed principles include (but are not limited to) Oasis, Spice net lists, VHDL, and Verilog. The processes, methods, systems, tools described herein are not limited in any way by the nature of the information to be secured and processed or the tools for the same.

### Concealment Of Unencrypted Secure EDA Related Information

With the various examples of the invention discussed above, the secured EDA related information has been logically secured, such as through encryption or obfuscation. With some examples of the invention, however, the secured EDA related information may be physically secured. For example, EDA related information may automatically be generated by an information generation tool. With this configuration, the generated EDA related information can be provided directly to the EDA tool in such a way that would discourage or even prevent unauthorized persons from intercepting the EDA related information. Thus, the information generation tool might provide the EDA tool with the EDA related information in a machine code format. With other implementations, an electronic medium containing the EDA related information might be physically delivered to the EDA tool by a secure courier, who can then supervise the use of the EDA related information. In still other implementations of the invention, the EDA related information might be provided to the EDA tool byte-by-byte over an electronic communication network. In some situations, the EDA-related information may be physically secured by a limited distribution of and/or access to the EDA-related information. Thus, the physical techniques used to provide the EDA related information to the EDA tool may inherently secure portions of the EDA related information.

Thus, these delivery techniques will physically secure all of the EDA related information as it is initially provided to an EDA tool. These delivery techniques typically will not protect the EDA related information from being accessed after it has been provided to the EDA related tool, however. For example, an unauthorized person might obtain useful data regarding the EDA related information from the results generated by the EDA tool.

Accordingly, various examples of the invention may an entity with the ability to protect one or more secure portions of the EDA related information from unauthorized access after it has been provided to the EDA tool. With these embodiments of the invention, the secure EDA related information is identified as such when it is provided to the EDA tool. The EDA tool will then subsequently protect the secure EDA related information by omitting or obfuscating any reference to the secure EDA related information from the process results, as discussed in detail above.

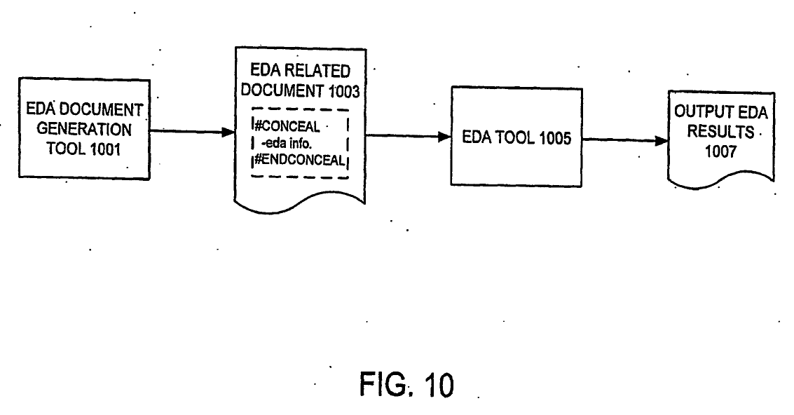

For examples, FIG. 10 illustrates a system that can protect unencrypted EDA related information from unauthorized access. As seen in this figure, an EDA document generation tool 1001 generates an EDA related document 1003 containing EDA related information. The EDA related document 1003 is provided directly to the EDA tool 1005, initially making all of the EDA related information secure. A portion of the EDA related information that should remain secure, however, is specifically designated for the EDA tool 1005. In the illustrated embodiment, for example, the beginning of the secured EDA related information is prefaced with the identifier “CONCEAL,” while the end of the secured EDA related information is followed by the corresponding identifier “ENDCONCEAL.” Of course, these particular identifiers are provided as an example only, and various embodiments of the invention may employ any type of desired indicators.

Upon detecting of the indicators, the EDA tool 1005 will treat the secured EDA related information as if it were logically secured (e.g., encrypted), as discussed in detail above. Thus, references to the secured EDA related information designated by the indicators will be omitted from or obfuscated in the output EDA results 1007 generated by the EDA tool 1005. More particularly, any references that might reveal information regarding the secured EDA related information either will be omitted from or obfuscated in the results 1007. As also discussed in detail above, the results 1007 may include output data, execution logs (such as operation or runtime message logs), error messages, output summaries and the like.

The EDA tool 1005 will also protect any portions of the designed secure EDA related information that may be provided to other EDA tools for processing. For example, the EDA tool 1005 may store a portion of the designated secured EDA related information in a database for subsequent use by another EDA tool. Alternately or additionally, the EDA tool 1005 may provide the designated secured EDA related information to another EDA tool using an unsecure delivery technique. With various embodiments of the invention, the EDA tool 1005 (or another corresponding tool) may encrypt that portion of the designed secure EDA related information, to ensure that it remains protected from unauthorized access. Thus, the EDA tool 1005 may encrypt portions of the designated secured EDA related information even if these portions were not encrypted when originally provided to the EDA tool 1005.

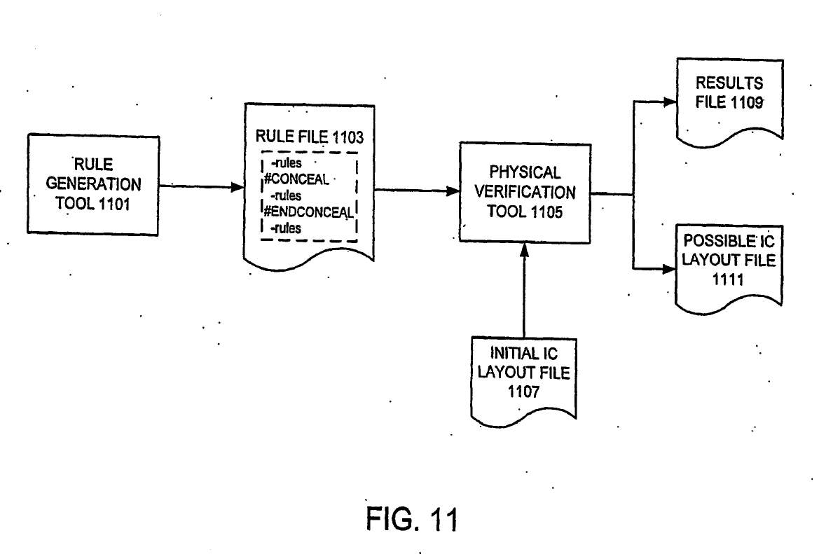

FIG. 11 illustrates an example of a physical verification process implementing these features of the invention. As seen in this figure, a rule generation tool 1101 generates a design rule file 1103 containing design rules. The rule generation tool 1101 has bracketed a portion of the rules using the indicators “CONCEAL” and “ENDCONCEAL,” to designate these rules as secure EDA related information. The design rule file 1103 is then directly provided to the physical verification tool 1105 thereby securing the entirety of the rule file 1103 from unauthorized access.

After receiving the design rule file 1103, the physical verification tool 1105 analyzes an initial integrated circuit layout file 1107 to determine if the circuit design contained in the circuit layout file 1107 complies with the rules in the rule file 1103. Based upon its analysis, the physical verification tool 1105 then generates verification results, includes a results file 1109 and a possible integrated circuit layout file 1111. As discussed in detail above, however, any reference to the designed rules is omitted from or obfuscated in both the results file 1109 and the possible integrated circuit layout file 1111. That is, any references that might reveal information regarding the secured rules will either be omitted from the results file 1109 and the possible integrated circuit layout file 1111, or obfuscated in the results file 1109 and the possible integrated circuit layout file 1111. Additionally, while not shown in this figure, any reference to the secured rules will be omitted from or obfuscated in any other results produced by the physical verification tool 1105, including execution logs (such as operation or runtime message logs), error messages, output summaries and the like.

### Implementation In A Distributed Network Environment

Any of the aspects of the technology described above may be performed or designed using a distributed computer network. FIG. 12 shows one such exemplary network. A server computer 1200 can have an associated storage device 1202 (internal or external to the server computer). For example, the server computer 1200 can be configured to process EDA information related to circuit designs using any of the embodiments described above (e.g., as part of an EDA software tool). The server computer 1200 may be coupled to a network, shown generally at 1204, which can comprise, for example, a wide-area network, a local-area network, a client-server network, the Internet, or other such network. One or more client computers, such as those shown at 1206, 1208, may be coupled to the network 1204 using a network protocol.

FIG. 13 shows that a client computer (e.g., 1206 and 1208) receives results (e.g., errors related to rule files and alternative IC design layouts that do violate selected rules) related to secure processing of EDA related information (e.g., IC rule files) according to any of the embodiments disclosed herein using a remote server computer, such as the server computer 1200 shown in FIG. 12. In process block 1350, for example, a client computer sends data related to EDA. For instance, a client computer may send a rule file, one or more proposed IC design layouts and other EDA information from a design database. In process block 1352, the data is received and secured by the server computer according to any of the disclosed embodiments. Alternatively, the client computer may secure the EDA information to be processed and send such secured EDA information to the server for processing.

In process block 1354, the EDA related information is processed according to any of the disclosed embodiments. In process block 1356, the server computer sends the results (e.g., errors related to rule files and alternative IC design layouts that so not violate selected rules) to the client computer which receives the database in process block 1358. It should be apparent to those skilled in the art that the example shown in FIG. 13 is not the only way to secure EDA related information, process the secured EDA related information and share the results of such processing without revealing the secured EDA related information. For instance, the client computer that sends the EDA related information (e.g., rule files) may not be the same client that receives the results. Also, the EDA related information may be stored in a computer-readable media that is not on a network and that is sent separately to the server. Or, the server computer may perform only a portion of the design procedures.

Having described and illustrated the principles of our invention with reference to the illustrated embodiments, it will be recognized that the illustrated embodiments can be modified in arrangement and detail without departing from such principles. For example, a file may comprise a master file in which multiple, individually protected files comprising EDA related information are included. Thus, for instance multiple IC manufacturers or other third-party entities in the design flow can contribute, use, and/or share rule files without revealing certain proprietary information.

### Conclusion

Elements of the illustrated embodiment shown in software may be implemented in hardware and vice versa. Also, the technologies from any example can be combined with the technologies described in any one or more of the other examples. Thus, for instance, any method, process, system or tool described herein with respect to secure processing of rule files for physical verification may be used in conjunction with other EDA related information for other EDA uses in other EDA related tools. In view of the many possible embodiments to which the principles of the invention may be applied, it should be recognized that the illustrated embodiments are examples of the invention and should not be taken as a limitation on the scope of the invention. For instance, various components of systems and tools described herein may be combined in function and use. I therefore claim as my invention all subject matter that comes within the scope and spirit of these claims.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of processing electronic design information by a design automation tool, comprising:
receiving electronic design information;
determining that a portion of the electronic design information should be concealed; and
processing the portion of the electronic design information such the portion of the electronic design information is concealed.

2. The method recited in claim 1, wherein the portion of the electronic design information includes an indicator indicating that the portion of the electronic design information should be concealed.

3. The method recited in claim 1, wherein processing the portion of the electronic design information includes providing process results that do not reveal the portion of the electronic design information.

4. The method recited in claim 3, wherein the results do not include any reference to the portion of the electronic design information.

5. The method recited in claim 3, wherein the results include only an obscured reference to the portion of the electronic design information.

6. The method recited in claim 3, further comprising providing the results to another electronic design automation tool.

7. The method recited in claim 1, wherein
the electronic design automation tool is a physical verification tool, and
the secured electronic design automation information includes rules related to manufacture of integrated circuits.

8. The method recited in claim 7, further comprising
receiving information related at least one integrated circuit layout, and
wherein processing the portion of the electronic design automation information includes verifying whether the at least one integrated circuit layout violates any of the rules related to manufacture of integrated circuits.

9. The method recited in claim 1, wherein the electronic design automation tool is a resolution enhancement tool

10. The method recited in claim 1, wherein the electronic design information is securely received by the design automation tool.

11. The method recited in claim 10, herein the electronic design information is securely received by the design automation tool directly from an electronic design information generation tool.

12. The method recited in claim 10, wherein the electronic design information is manually provided to the design automation tool.

13. A system for processing electronic design automation information, comprising an electronic design automation tool operational for:
receiving electronic design information;
determining that a portion of the electronic design information should be concealed; and
processing the portion of the electronic design information such the portion of the electronic design information is concealed.

14. The system recited in claim 13, wherein the portion of the electronic design information includes an indicator indicating that the portion of the electronic design information should be concealed by the electronic design automation tool.

15. The system recited in claim 13, wherein the electronic design automation tool is further operational for providing process results that do not reveal the portion of the electronic design information.

16. The system recited in claim 15, wherein the process results do not include any reference to the portion of the electronic design information.

17. The system recited in claim 15, wherein the process results that include only an obscured reference to the portion of the electronic design information.

18. The system recited in claim 15, wherein the electronic design automation tool provides the process results to another electronic design automation too.

19. The system recited in claim 13, wherein
the electronic design automation tool is a physical verification tool, and
the secured electronic design automation information includes rules related to manufacture of integrated circuits.

20. The system recited in claim 19, wherein
the physical verification tool is further operational for
receiving information related at least one integrated circuit layout, and
processing the portion of the electronic design automation information by verifying whether the at least one integrated circuit layout violates any of the rules related to manufacture of integrated circuits.

21. The method recited in claim 13, wherein the design automation tool is operational for securely receiving the electronic design information.

22. The system recited in claim 21, further comprising an electronic design information generation tool that provides the electronic design information directly to the design automation tool.

23. The method recited in claim 21, wherein the design automation tool is further operational for securely receiving the electronic design information manually.
